(19) United States
(12) Patent Application Publication
(10) Pub. No.: US 2009/0202468 A1
(43) Pub. Date: Aug. 13, 2009

(54) Attractant compounds for yellow jacket wasps

(76) Inventor: Renato Ripa Schaul, La Cruz (CL)

Correspondence Address: STRATTON BALLEW, 213 S 12TH AVE, YAKIMA, WA, 98902, US

(21) Appl. No.: 12/317,799

(22) Filed: Dec. 27, 2008

(30) Foreign Application Priority Data
Dec. 27, 2007 (CL) 3850-2007

(51) Int. Cl. A01N 25/00; A01P 19/00

(52) U.S. Cl. 424/84

(57) ABSTRACT

The use of individual chemical compounds as attractants in traps for yellow jacket wasps Vespula germanica, and more specifically, the use of certain alcohols of more than 7 carbon atoms, aldehydes more than 4 carbon atoms, and cetones more than 6 carbon atoms as attractants for specific yellow jacket wasps V. germanica, in traps placed in locations where these insects are pests.

### TECHNICAL FIELD

This invention relates to the use of individual chemical compounds as attractants in traps for yellow jacket wasps Vespula germanica. More specifically, it refers to the use of certain alcohols of more than 7 carbon atoms, aldehydes more than 4 carbon atoms, and cetones more than 6 carbon atoms as attractants for specific yellow jacket wasps Vespula germanica, in traps placed in locations where these insects are pests.

### BACKGROUND OF THE INVENTION

Referent to the compositions of the attractants of yellow jacket wasps V. germanica, it is known in the state of the art, the following patents: Gaines Eddy et al., EPO, 1975, which uses as attractant the butyrate 2.4-hexadienil; U.S. Pat. No. 4,851,218 (1989) from Hildebrandt et al., in which uses tricosene plus alkanes; U.S. Pat. No. 6,083,498 (2000) from Peter Landolt, which uses a mixture of acetic acid plus isobutanol; U.S. Pat. No. 6,740,319 (2004), Aldrich Jeffrey, using (E)-2-hexenal/linalool plus Acetic acid/isobutanol, and U.S. Pat. No. 6,652,846 (2003) by Long Roger, which uses acetic acid with protein foods.

The compounds known in the state of the art have two major disadvantages: one is that the chemical compounds used evaporate or oxidize easily, which requires a constant replenishment of them in the traps or monitoring stations, and baits placed in the field aimed at controlling these insects, and the other disadvantage is that they are not completely selective for the attraction of V. germanica.

It is desirable to have efficient, attractive and selective compounds, applicable in different field environments. This is the purpose of the present invention.

### BRIEF DESCRIPTION OF DRAWINGS

FIG. 1, shows the trap used in assessing each individual chemical compound of the invention, or the solution of acetic acid with isobutanol considered as the standard attractant according to the state of the art.

### DETAILED DESCRIPTION OF SPECIFIC EMBODIMENTS

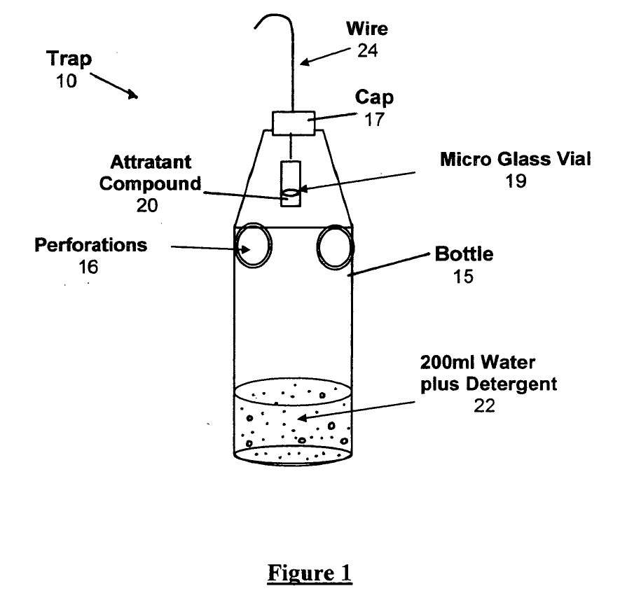

Attractant were evaluated in traps 10, as shown in FIG. 1, consisting of discardable plastic beverage bottles 15, of 500 ml, with two lateral openings, or perforations 16, 2.3 cm in diameter, each located at approximately the upper half of the bottle. On the top inside of the bottle, 2 cm below the cap 17, a 10 ml ‘micro’ glass vial 19 was installed. In this small container, 0.1 ml of an attractive compound 20 was deposited. In the bottom of the 500 ml bottle, 200 ml of water with liquid household detergent 22 was placed.

The traps 10 or containers with the attractant 20, were placed randomly in different species of trees, mostly ‘thorns,’ Acacia cavens and Tebo, Trevoa trinervis in Catapilco, ‘wicker’ at Lo Orozco, and apple trees in Casablanca (Chile), each hung from a wire 24, at a height of about 1½ m from the ground, with a separation between them of about 10 m. Two replications were used per each attractant in Catapilco, and five replications in Lo Orozco and Casablanca.

The traps 10 were placed in Catapilco in the Manantiales farm the 19^{th} of February 2007, in the geographical locations of 33°37′06″S and 71°19′14″O, for the Campo Lindo farm in Casablanca in 33°14′23″S and 71°17′37″O the 20^{th} of February 2007 and Lo Orozco in 33°13′26″S and 71°24′04″O the 9^{th} of April 2007.

To determine the attractiveness of different attractants 20, the trapped wasps and other insects were counted and withdrawn regularly from the detergent solution 22. In the extent it was necessary the containers were filled up with water and detergent. The traps 10 were checked in Casablanca on February 23 and 27, and March 6 and 9, in Catapilco on February 21 and 26 and March 8, and in Lo Orozco on April 11, 13, 16, 18, 20, 23, 25, 27 and May 2, 2007.

The results obtained with the individual chemical attractants 20; with alcohol, aldehyde, and cetone type, such as trans-2-octen-1-ol, 1-dodecanol; valeraldehyde, heptaldehyde, octyl aldehyde, nonyl aldehyde, trans-2-heptenal, trans,trans-2,4-nonadienal, trans,trans-2,4-decadienal; 2-heptanone, 2-octanone, 3-octanone, and 2-nonanone respectively, are given in Tables 1 and 2 below.

Table 1, below, shows the total number of yellow jacket wasps, V. germanica, and other insects caught, or attraction efficiency and selectivity of the different chemical attractants tested.

TABLE 1

| | |
|---|---|
| Catapilco | Casablanca |

| | | V. | Other | | |
|---|---|---|---|---|---|
| | CAS Number | germanica | insects | V. germanica | Other insects |
| 1-Dodecanol | 111-53-8 | 0 | 0 | 102 | 1 Sirfid |
| 2-Nonanone | 821-55-6 | 0 | 0 | 178 | 0 |
| Trans,trans-2,4- | 5910-87-2 | 0 | 0 | 218 | 0 |
| nonadienal | | | | | |
| Nonyl aldehyde | 124-19-6 | 1 | 3 Bees | 97 | 0 |
| Octyl aldehyde | 124-13-0 | 3 | 0 | 101 | 0 |
| Heptaldehyde | 111-71-7 | 9 | 0 | 129 | 0 |
| Valeraldehyde | 110-62-3 | 24 | 0 | 84 | 0 |
| 2-Heptanone | 110-43-0 | 69 | 0 | 92 | 0 |
| Trans,trans-2,4- | 25152-84-5 | 84 | 0 | 5 | 0 |
| decadienal | | | | | |
| 3-Octanone | 106-68-3 | 356 | 1 | 218 | 0 |
| | | | Polistes, | | |
| | | | 1 Bee | | |
| Trans-2- | 18829-55-5 | 407 | 0 | 252 | 0 |
| heptenal | | | | | |
| 2-Octanone | 111-13-7 | 416 | 0 | 209 | 1 Moth |
| Trans-2-octen- | 18409-17-1 | 474 | 1 Bee | 297 | 0 |
| 1-ol | | | | | |

Total number of V. germanica workers and other insects captured by each attractant indicated in the Manantiales farm in Catapilco and in Campo Lindo farm in Casablanca, for 17 and 18 days respectively using two containers 10 per attractant 20.

From the previous field results, it was found that the yellow jacket wasps were practically the only insects attracted to the traps with individual chemical compounds. In this regard, considering the high catch V. germanica and the small number of other species of insects attracted, the high selectivity of these compounds attractive to this kind of wasp is verified.

This proves the important value in using these individual chemical compounds, particularly when they have a lower vapor pressure which makes them very persistent because they evaporate at a lower rate in real field conditions, while in the standard mixture of acid acetic and isobutanol occurs a rapid evaporation which obliges their frequent replacement.

Table 2, below, shows the total number of yellow jacket wasps, V. germanica and other captured insects, or attraction efficiency and selectivity of the different attractants which includes also the mixture of acetic acid with isobutanol, which is a standard attractant.

TABLE 2

| | | | | Other |
|---|---|---|---|---|
| | V. germanica | Bees | Polistes | insects |
| 3-octanone | 892 | 0 | 0 | 0 |
| Trans-2-heptenal | 999 | 0 | 0 | 0 |
| Trans-2-octen-1-ol | 2.028 | 2 | 1 | 0 |
| 2-Octanone | 2.673 | 0 | 1 | 0 |
| Mixture of Acetic Acid/ | 2.230 | 1 | 1 | 5 flies, |
| isobutanol 1:1 | | | | 2 moths |
| Control water and | 440 | 1 | 1 | 0 |
| detergent | | | | |

Total number of V. germanica workers and other insects captured by each attractant indicated in Lo Orozco, during 21 days, using five containers 10 per attractant 22.

As can be seen from these field tests, 2-octanone is superior than the mixture of acetic acid with isobutanol. But most important of these field tests is that while the standard mixture of acetic acid/isobutanol (1.0 ml) is effective, it is only possible because it had to be replenished every 5 days by adding this attractant because it evaporates quickly in the experimental conditions in the field. Instead, the individual chemical compounds (0.1 ml) remained active, with no replenishment in the trials of Casablanca and Catapilco, with a duration of 17 to 18 days, while those more volatile attractants in Lo Orozco as 3-octanone and the mixture of acetic acid with isobutanol, had to be replenished every 3 or 5 days. In this way most of the chemical attractants showed a lower rate of evaporation, due to their lower vapor pressure. This demonstrates the practical superiority of the individual chemical compounds over the standard mixture of acetic acid with isobutanol, both for its attraction as for their persistence or permanence in the field conditions. This leads to the permanence of the chemical compounds of this invention between 10 and 100 times in field conditions without replacement as compared to the standard mixture of acetic acid with isobutanol.

The following is claimed:

1. Using individual organic chemical compounds as attractants for trapping the yellow jacket wasp, Vespula germanica, type alcohol, aldehyde, and cetone, such as trans-2-octen-1-ol, 1-dodecanol; valeraldehyde, heptaldehyde, octyl aldehyde, nonyl aldehyde, trans-2-heptenal, trans,trans-2,4-nonadienal, trans,trans-2,4-decadienal; 2-heptanone, 2-octanone, 3-octanone, and 2-nonanone respectively, characterized because these compounds attract in an efficient and selective way the yellow jacket wasp V. germanica, and not other insects.

2. Use of organic chemical compounds as attractants inside a trap for the yellow jacket wasp, V. germanica, according to claim 1, characterized because the most effective attractants are the alcohol trans-2-octen-1-ol, the aldehyde trans-2-heptenal, and the cetones 2-octanone and 3-octanone.

3. Using organic chemical compounds such as attractants inside a trap for the yellow jacket wasp, V. germanica, according to claim 2, characterized because its activity is higher than that exerted by the attractant formed by the mixture of isobutanol with acetic acid which is used as a standard.

4. Using organic chemical compounds such as attractants inside a trap for the yellow jacket wasp, V. germanica, according to claims 1 and 2, characterized because they are used in quantities of less than 0.1 ml per 500 ml trap.

5. Using organic chemical compounds such as attractants inside a trap for the yellow jacket wasp, V. germanica, according to claim 4, characterized because they are of high persistence in the field.

6. Using organic chemical compounds such as attractants inside a trap for the yellow jacket wasp, V. germanica, according to the claims 4 and 5, characterized because their persistence in the field is approximately 10-100 times greater than the attractant mixture formed by acetic acid with isobutanol 1:1.
